(19) United States
(12) Patent Application Publication
(10) Pub. No.: US 2005/0078179 A1
(43) Pub. Date: Apr. 14, 2005

(54) Modulate aptamer and method for detecting target protein by using the same

(76) Inventor: Takeshi Hamada, Chiba-shi Chiba (JP)

Correspondence Address: Jonathan P Osha;Osha & May, Suite 2800, 1221 McKinney Street, Houston, TX, 77010, US

(21) Appl. No.: 10/499,806

(22) PCT Filed: Feb. 20, 2004
(86) PCT No.: PCT/JP04/01969

(30) Foreign Application Priority Data
Oct. 8, 1999 (JP) 11/288677

(51) Int. Cl. H04N 9/47

(52) U.S. Cl. 348/143

(57) ABSTRACT

Assuming that the energy amount of a macro block i at time t is Pi (l, t), the energy amount of the macro block i at time (t+T) is represented as Pi (l, t+T). By comparing the energy amounts Pi (l, t) and Pi (l, t+T), the change of the energy amount after the elapse of time T from time t can be obtained. From the state of this change, the state of an object can be monitored.

### TECHNICAL FIELD

The present invention relates to a monitoring apparatus, and more particularly, to a monitoring apparatus having a sensor which performs a function similar to human eyes.

### BACKGROUND ART

In recent years, monitoring apparatuses have been used in widespread fields. For example, monitoring apparatuses are installed at factory production lines for checking defective products, and are installed at stores and homes for security purposes and the like. Here, in known monitoring apparatuses, in general, the image of an object is picked up using an image-pickup device such as a CCD, or the like, and image recognition is performed based on the obtained image signal in order to determine whether something is abnormal or not.

However, in the image recognition based the image signal obtained from an image-pickup device in the known monitoring apparatuses, the time-series change of an object to be monitored is captured, and for example, a determination is made of whether or not a past image matches a current image. If both images do not match, some action is taken, for example, an alarm is raised. However, setting aside unmanned warehouses or the like, when an image-pickup device is installed on the streets or the like, there is hardly a case where a past image completely matches a current image. It has been, therefore, difficult to determine whether or not an abnormal change has occurred from the obtained image signal.

In order to solve such a problem, in Japanese Patent Application Laid-open No. 2000-341679, by picking up monitored images at a plurality of timings, the background images are obtained and registered. By comparing the background images with the current image, for example, even if illuminations, which exist in the background, blink, a determination that it is abnormal is avoided.

However, since illuminations are fixed and the blinking thereof is performed on a regular basis, it is easy to register them as background images. On the contrary, in a situation where objects change from moment to moment, and thus the same scene never appears, such as a hustle and bustle, even if background images can be registered using the technique described above, it is difficult to determine whether or not something abnormal has occurred using the registered image. On the other hand, human eyes have a feature, in which for example, when idly looking a hustle and bustle or the like, if there is not a significant change, the scene can be ignored as background noises, however, for example, if a man with a strange appearance passes by, the incident can be immediately recognized and attention can be paid.

Also, in order to prevent illegal copying, a technique for adding a watermark (watermarking) of a trademark or the like to a video signal is known. However, adding a watermark means that the original video signal is replaced with another signal, and thus the possibility of damaging the original video image increases with an increase of the additional signal. Also, by applying repeated compression, analog conversion, format conversion, and the like to the video signal having a watermark, there is the possibility that the watermark is damaged, and does not work as an identification signal. In particular, when watermarking a video signal, there is no way to differentiate it from the watermarking of a still image, and thus there is a problem in that a watermarking technique is not always effective.

### DISCLOSURE OF INVENTION

The present invention has been made in order to solve such a known problem, and an object is to provide a monitoring apparatus having a sensor which closely resembles the characteristics of human eyes.

Another object of the present invention is to provide a monitoring apparatus which can determine whether or not another image or video is produced by copying without damaging the original image signal or video signal.

A monitoring apparatus of the present invention includes: a visual sensor which recognizes an object and converts into an energy amount; and
analyzing means which monitors the energy amount from the visual sensor and raises an alarm based on a time-series change and a threshold value of the energy amount.

According to the monitoring apparatus of the present invention, since the monitoring apparatus has a visual sensor which recognizes an object and converts into an energy amount; and analyzing means which monitors the energy amount from the visual sensor and raises an alarm based on a time-series change and a threshold value of the energy amount, it is possible to ignore a minor change of the object, and to capture only a major change for raising an alarm.

Furthermore, the visual sensor preferably obtains an energy amount for each divided area (for example, a macro block) produced by dividing an object image.

A monitoring apparatus of the present invention includes: calculation means for calculating an energy amount of a predetermined area in digital data corresponding to an original image and calculating an energy amount of a predetermined area in digital data corresponding to a comparison target image; and
determination means for determining whether or not the comparison target image is formed based on the original image by comparing the two energy amounts calculated by the calculation means.

According to the monitoring apparatus of the present invention, since the monitoring apparatus has determination means for determining whether or not the comparison target image is formed based on the original image by comparing the two energy amounts calculated by the calculation means, it is not necessary to watermark the digital data constituting the original image, and thus the original data is not damaged. Also, the characteristic of the energy amount is not changed so much by the processing such as digital data compression or the like, and thus even if the comparison target image is highly processed, it is possible to clarify the correlation with the original image.

### BRIEF DESCRIPTION OF THE DRAWINGS

FIG. 1 is a general configuration diagram of a monitoring apparatus according to a first embodiment.

FIG. 2 is a diagram schematically illustrating a screen on which images are picked up by an image-pickup device 2.

FIG. 3 is a diagram schematically illustrating the energy amount of each block.

FIG. 4 is a diagram illustrating the time-series change of the energy amount.

FIG. 5 is a general configuration diagram of a monitoring apparatus according to a second embodiment.

FIG. 6 is a diagram illustrating time-series changes of energy amounts by comparison.

### BEST MODE FOR CARRYING OUT THE INVENTION

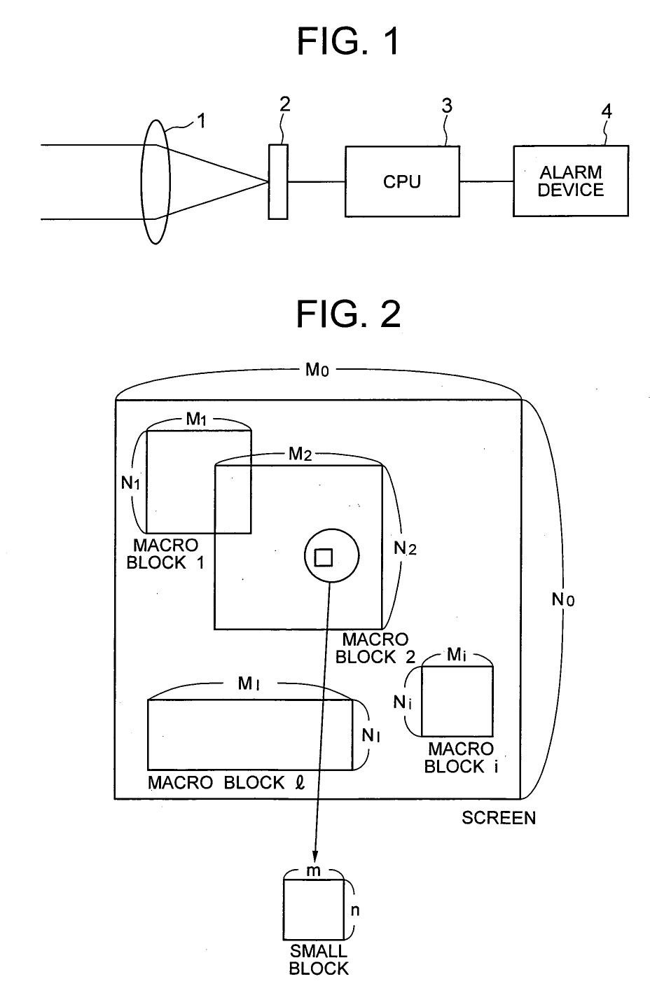

A description will be given of a first embodiment of the present invention with reference to the drawings. FIG. 1 is a general configuration diagram of a monitoring apparatus according to the first embodiment. In FIG. 1, the image of an object is formed on a light receiving surface of an image-pickup device (CCD or the like) 2 by an optical system 1, and then is converted into an electric signal here. This electric signal is input into a CPU 3 and is analyzed. The CPU 3, which is analyzing means, drives an alarm device (monitor, speaker, and the like) 4 to raise an alarm under a predetermined condition. In this regard, the image-pickup device 2 and the CPU 3 constitute a visual sensor.

A description will be given of a specific contents of the analysis of the CPU 3. FIG. 2 is a diagram schematically illustrating a screen on which images are picked up by the image-pickup device 2. On the screen shown in FIG. 2, Mo pieces of pixels are arranged in a lateral direction and No pieces of pixels are arranged in a vertical direction. This screen is divided into I pieces of macro blocks. The division of the screen by the macro blocks may be such that each of the macro blocks has a different size with each other, and the macro blocks may overlap each other. Note that the macro block is evenly divided by small blocks having a vertical size×a lateral size=n×m pixel sizes. That is to say, assuming that ai and bi are integers, Mi=aim, Ni=bin (i=0, . . . , I). At this time, the original screen also needs to be evenly divided into small blocks.

Here, the energy amount P of a small block SB is expressed by the following expression 1.

$$\begin{matrix}P = \frac{1}{m \cdot n} {\sum }_{x = 1}^{m} {\sum }_{y = 1}^{n} {( S ( x , y ) - \overline{S} )}^{2} \\ \overline{S} = \frac{1}{m \cdot n} {\sum }_{x = 1}^{m} {\sum }_{y = 1}^{n} S ( x , y ) \end{matrix} \qquad [ Expression 1 ]$$

Note that S(x, y) is each sample value (pixel value) in the small block SB.

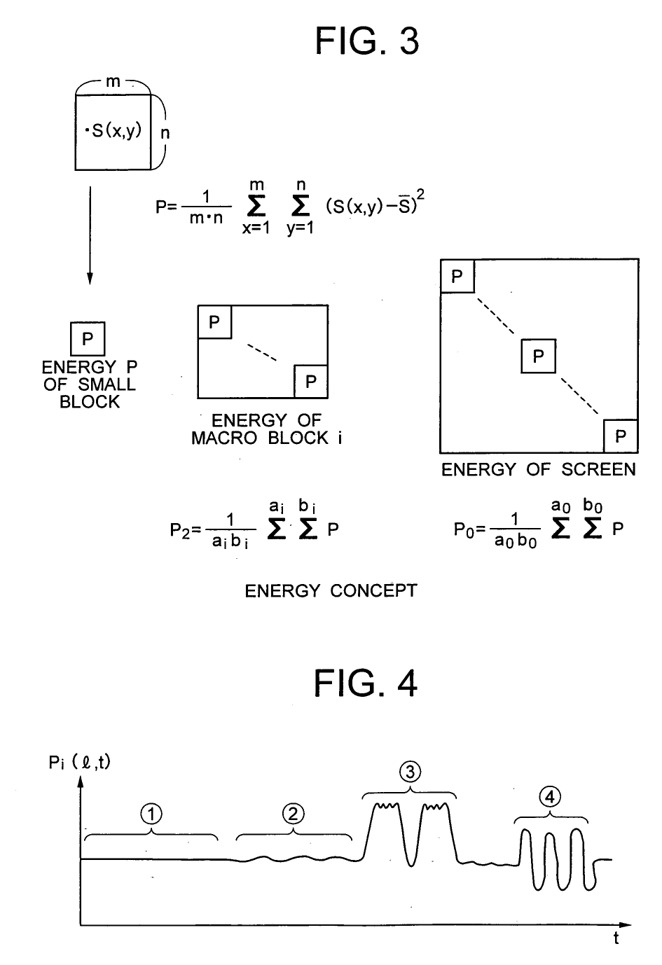

Also, the energy amount Pi of a macro block i is defined as an average value of small blocks included in the macro block i. The energy amount Po of the screen is defined as an average value of small blocks included in the screen P (refer to FIG. 3).

Next, the change of each energy amount Pi over time is monitored. More specifically, the CPU 3 picks up images at regular time intervals, thus obtains each energy amount Pi with respect to the image obtained from the image-pickup device 2, and stores it into an internal memory.

Here, for example, assuming that the energy amount of a macro block i at time t is Pi (l, t), the energy amount of the macro block i at time (t+T) is represented as Pi (l, t+T). By comparing the energy amounts Pi (l, t) and Pi (l, t+T), the change of the energy amount after the elapse of time T from time t can be obtained. From the state of this change, the state of the object can be monitored.

Here, it is assumed that monitoring is performed by classifying an object of monitoring into four states, which are “still”, a “mild change”, a “sharp change”, and a “cyclic change”. An example of plotting the time along the horizontal axis and the energy amount Pi of the macro block i along the vertical axis is shown in FIG. 4. Here, in the graph shown in FIG. 4, the range (1) corresponds to the “still”, the range (2) corresponds to the “mild change”, the range (3) corresponds to the “sharp change”, and the range (4) corresponds to the “cyclic change”. When applying the present invention to a monitoring apparatus at a store for selling goods, for example, the “still” corresponds to a peopleless state before an opening time, the “mild change” corresponds to a state in which customers are doing shopping after opening the store, and the “sharp change” corresponds to a state in which a burglar or the like has broken into the store and people in the store have rapidly moved. Also, an illumination and a hazard lamp of a car, and the like correspond to (4) the “cyclic change”. Accordingly, if the variation of the energy amount Pi corresponding to (3) in FIG. 4 is stored as a threshold value, when the resultant variation of the analysis of the CPU 3 based on the electric signal output from the image-pickup device 2 is greater than the threshold value, an alarm is automatically raised. By this means, an unmanned monitoring system having the same function as human eyes is constructed.

In this regard, the change of the energy amount Pi occurs in a plurality of places of macro blocks i. It is, therefore, possible not to raise an alarm when one macro block i outputs a variation pattern of the energy amount Pi corresponding to (3), and another macro block i outputs a variation pattern of the energy amount Pi corresponding to (2). At this time, if a specific macro block i includes the image of the vicinity of a cash register, the energy amount Pi of that macro block is weighted, and a comprehensive determination is made together with the energy amount Pi of the other macro blocks i. Thus it is possible to raise an alarm more accurately.

In the following, a description will be given of the modes for classifying the target of the monitoring.

(1) Still

The target of the monitoring included in the macro block i is determined to be still when the following conditions are met in a certain period of time T. More specifically, assuming that the change of the energy amounts of the included small blocks is obtained as:
ΔP(l, t)=|P(l, t)−P(l, t−1)|,
if the following expressions are met for all the small blocks included in the macro block i, the target of the monitoring included in the macro block i is determined to be still.
|ΔP(l, t)|≦Th1, for all t=1, . . . T
and

$${\sum }_{t = t}^{t + T} Δ P ( l , t ) \leq Th2 \qquad [ Expression 2 ]$$

The threshold values Th1 and Th2 can be determined from the experiments or the like.
(2) Mild Change

If still conditions are not met for a certain period of time T, it is determined that the target of the monitoring changes mildly. Here, the energy amount of the macro block i is used. More specifically, assuming that the change of the energy amount Pi of a macro block i is obtained as:
ΔPi (1, t)=|Pi (1, t)−Pi (1, t−1),
if the following expression holds, it is determined that the target of the monitoring changes mildly.

$${\sum }_{t = t}^{t + T} Δ Pl ( l , t ) 〉 Th 3 \qquad [ Expression 3 ]$$

The threshold value Th3 can be determined from the experiments or the like.
(3) Sharp Change

The target of the monitoring is determined to be sharply changing when the following conditions are satisfied in a certain period of time T. Here, the energy amount of the macro block i is used. The energy density dPi (l, t) of the macro block i at time t is defined by the following expression.

$$dPi ( l , t ) = \frac{1}{Td} {\sum }_{i = t - td}^{t} \vert Pi ( l , t ) - Pi ( l , t - 1 ) \vert \qquad [ Expression 4 ]$$

Here, if dPi (l, t)≧Thd, it is determined that the target of the monitoring is sharply changing. The threshold value Thd can be determined from the experiments or the like.
(4) Cyclic Change

Fourier transform processing is performed on the energy amount Pi of the macro block i. If a concentration of the energy on a specific frequency pulse is recognized, it is determined to be a cyclic change.

The present invention is not to be construed as limited to the embodiment described above, and appropriate changes and improvements are, of course, possible. For example, in addition to the monitoring apparatus for security purposes, the monitoring apparatus of the present invention can be used for monitoring the appearances of patients at a hospital, or can be on board a vehicle for monitoring the outside traffic situations, thereby making it possible to prevent a traffic accident from occurring.

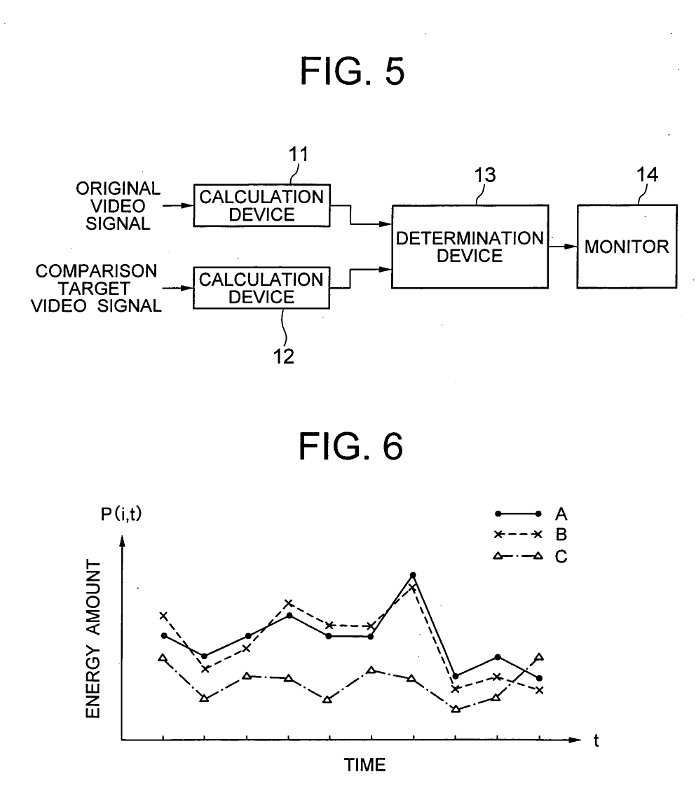

A description will be given of a second embodiment of the present invention with reference to the drawings. FIG. 5 is a general configuration diagram of a monitoring apparatus according to the second embodiment. In FIG. 5, an original video signal is input into a first calculation device 11 through an interface not shown in the figure. At the same time, a comparison target video signal is input into a second calculation device 12 through an interface not shown in the figure.

The calculation devices (calculation means) 11 and 12 extracts a specific block (may be all the screen) of the same position, and repeats calculation of the energy amount therein at the same time intervals using the above-described expression 1. Thereafter the calculation devices 11 and 12 input the obtained calculation result to a determination device (determination means) 13.

The determination device 13 compares the energy amount PA (i, t) of the original video signal and the energy amount PB (i, t) of the comparison target video signal. When the energy amount is shown on the vertical axis and the time axis is on the horizontal axis, by plotting the calculated energy amounts by each time, for example, a graph as shown in FIG. 6 is obtained.

Here, the determination device 13 obtains, by each time, the difference between the energy amount PA (i, t) of the original video signal and the energy amount PB (i, t) of the comparison target video signal, and then obtains the sum value Δ of those using the following expression 5.

$$Δ = \frac{1}{T} {\sum }_{t = 1}^{T} \vert {P}_{A} ( i , t ) - {P}_{B} ( i , t ) \vert / W ( {P}_{A} , {P}_{B} ) \qquad [ Expression 5 ]$$

In this regard, W is a weighting function, and for example, W(PA, PB)=log10(PA+PB) can be used.

Here, if Δ=0, the determination device 13 determines that the original video signal and the comparison target video signal perfectly match (Perfect match), that is to say, that they are the same video signal. On the other hand, if 0<Δ<TH (threshold value), the determination device 13 determines that the comparison target video signal (for example, a graph B in FIG. 6) nearly matches (Nearly match) the original video signal (for example, a graph A in FIG. 6), and is the signal produced by performing some processing on the original video signal. Furthermore, if TH (threshold value)<Δ, the determination device 13 can determine that the comparison target video signal (for example, a graph C in FIG. 6) does not match (Not match) the original video signal (for example, the graph A in FIG. 6), and is irrelevant to the original video value. These determination results are input to the monitor 14 from the determination device 13, and thus the user can recognize the determination result of the determination device 13 by viewing the monitor 14.

According to the monitoring apparatus of the present invention, if a video signal recorded on a DVD or the like is the signal produced by performing processing on the original video signal, by comparing the difference of the energy amounts with the threshold value Δ, it is possible to objectively derive the relationship with the original video signal, and thereby it is possible to provide one determination criterion of whether or not it is produced by illegal copying.

1. A monitoring apparatus comprising: a visual sensor which recognizes an object and converts into an energy amount; and
analyzing means which monitors the energy amount from the visual sensor and raises an alarm based on a time-series change and a threshold value of the energy amount.

2. A monitoring apparatus according to claim 1, wherein the visual sensor obtains an energy amount for each divided area produced by dividing an object image.

3. A monitoring apparatus comprising: calculation means for calculating an energy amount of a predetermined area in digital data corresponding to an original image and calculating an energy amount of a predetermined area in digital data corresponding to a comparison target image; and
determination means for determining whether or not the comparison target image is formed based on the original image by comparing the two energy amounts calculated by the calculation means.
